(19) United States
(12) Patent Application Publication
(10) Pub. No.: US 2019/0133289 A1
(43) Pub. Date: May 9, 2019

(54) HANDS-FREE MOTION-TRACKING HAIR DRYER SYSTEM

(71) Applicants: Michael Rocha, Playa del Rey, CA (US); Kent Yu, Santa Monica, CA (US); Paul Pofcher, Santa Monica, CA (US)

(72) Inventors: Michael Rocha, Playa del Rey, CA (US); Kent Yu, Santa Monica, CA (US); Paul Pofcher, Santa Monica, CA (US)

(73) Assignee: T3 Micro, Inc., Venice, CA (US)

(21) Appl. No.: 16/241,920

(22) Filed: Jan. 7, 2019

Related U.S. Application Data
(63) Continuation-in-part of application No. PCT/US2017/041185, filed on Jul. 7, 2017.
(60) Provisional application No. 62/360,069, filed on Jul. 8, 2016.

(51) Int. Cl. A45D 20/16; B25J 11/00; B25J 9/00

(52) U.S. Cl. CPC A45D 20/16; B25J 9/0009; B25J 9/0003; B25J 11/008

(57) ABSTRACT

A hands-free motion tracking hair dryer system may include a base, an air flow generator, a conduit through which the air flow passes, and a heating element to selectively heat the air flow. The conduit may be coupled to the air flow generator and channel the air flow to an outlet nozzle, and includes a telescoping joint between the air flow generator and the outlet nozzle. The system includes an actuator that changes the length of the conduit at the telescoping joint while the air flow is passing therethrough, and a motion tracker that can sense a motion of the user. An actuator control circuit drives the actuator based on the motion sensed by the motion tracker, to adjust the conduit length in response to the motion of the user.

### CROSS-REFERENCE TO RELATED APPLICATIONS

This application claims priority under 35 USC § 365(c) and 35 USC § 120 as a continuation-in part to pending International Application No. PCT/US2017/041185 filed on 2017 Jul. 7, and published on 2018 Jan. 11 as international publication number WO 2018/009859A1 entitled “Motion Sensing Hair Dryer,” and thereby this application also claims priority to U.S. Provisional Application Ser. No. 62/360,069 filed 2016 Jul. 8.

### BACKGROUND

The present disclosure relates to an apparatus of a hair drying unit with a motion sensing tracker to free a user's hands for convenience or artistic styling of the hair.

Among conventional hair treatment apparatuses for blowing air are a hand dryer which is held by hand and blows hot air to a desired portion of the head. However, using a hand-held dryer requires strength and good hand-eye coordination, especially for women with long hair. Maneuvering a hairbrush, the way needed to get a sleek salon style while holding hair dryer at the same time makes things harder and more complicated for the user at home. Numerous attempts to solve this problem have been made.

U.S. Pat. No. 8,082,679 to Arnim describes a device and method for directing heated air from a hair dryer onto the hair while brushing or combing the hair. The hair dryer is fitted with a pivoting nozzle that follows a brush or combing device. The position of the nozzle relative to the brush is preferably controlled through magnetic attraction. However, this device does not free a user's hands for convenience or artistic styling of the hair, and the range of motion is limited.

U.S. Patent Publication No. 2004/0168337 to Curtin describes a hands-free dryer which can move over a wide range of angles in order to dry the surface of a person's hair or body. The position of the dryer is controlled by a preprogrammed or programmable control unit. An infrared or radio frequency transceiver may be used for detecting the presence or absence of a user, to determine whether the dryer should turn itself off (e.g. to save energy). However, the dryer does not track the movements of the user while she is styling; rather, the user must manually position the direction of the air flow.

U.S. Pat. No. 5,640,781 to Carson describes a ceiling or wall mounted hair styling unit that supplies hot or cold air through a hollow delivery tube to an adjustable nozzle leaving the user's hands free to manipulate hair styling tools. The user controls the amount of heat and volume of air with a wireless, remote control contained in the handle of a hair brush or within a foot-operated wireless signaling device, leaving both hands free. However, the position of the nozzle is set manually, not actively controlled.

U.S. Pat. No. 9,408,452 to Al-Khulaifi discloses a robotic hair dryer holder system with position tracking. However, the Al-Khulaifi robotic holder is a complex multi-degree-of-freedom control system that holds and moves a conventional hair dryer—i.e. a complete hair dryer that would otherwise be hand-held and therefore includes all necessary components (e.g. fan, housing, heating element, switch controls, etc.). Consequently, the distal mass moved by the Al-Khulaifi robotic holder is relatively large, which limits the bandwidth of its positioning control. Moreover, the multi-degree-of-freedom complexity of the Al-Khulaifi system causes it to be expensive to manufacture and to ultimately consume more space in the user's bathroom or salon.

Other attempts to solve the “hands-free” problem include a bonnet dryer, worn over the hair like a hood or cap. While leaving the hands free, it is slow to dry the hair and leaves insufficient room underneath for styling. Other solutions are merely stands, either telescoping or articulated, that hold a hair dryer in a fixed position to allow the user to keep both hands free for styling. However, the user either needs to move her head or the stand as she styles.

Thus, there is there is a need in the art for an improved hands-free hair dryer that can follow the movements of the user, that can be manufactured with practically low cost for widespread marketability to the general public at a profit, that uses a practically small space within the user's bathroom or salon, that has reduced moving mass for higher positioning bandwidth, that has improved service life or reliability, or that provides one or more of the foregoing advantages while enabling a simpler and more streamlined design.

### SUMMARY

The present application discloses a hands-free hair dryer system having an airflow that automatically tracks some or all of the user's movements. Certain embodiments of the disclosed hands-free hair dryer system may include an object to be tracked (“trackable object”), a tracking system (“tracker”) that can sense the location or motion of the trackable object, an air flow generator, heating element to optionally warm the air flow, and a positioning system that can direct the air flow towards the user's face, hair, head, or the trackable object. The trackable object may be wearable on the user or incorporated into a hair styling tool. The hands-free hair dryer system may also include and communicate with a remote controller to control certain functions of the dryer (e.g. air flow, temperature, etc.).

The inventors herein discovered that not all directions of hair dryer positioning are equally important for closed-loop tracking of user motion while styling hair, so that a subset of directions of positioning may instead be manually set once by the user and not actively controlled thereafter. Such embodiments in which the number of degrees-of-freedom required for active closed-loop positioning control has been so reduced (e.g. allowing initial user-set positioning in three dimensions, but actively orienting the air flow in only one dimension) may provide improved system simplicity and manufacturability, and reduced cost and size. Certain embodiments herein have reduced moving mass, for example by actively positioning only a hollow air conduit and nozzle, without a need to move the mass of the air flow generator, and/or the heating element.

### BRIEF DESCRIPTION OF THE DRAWINGS

For the purposes of illustration, there is shown in the drawings exemplary embodiments, but the claims define their own bounds and are not limited to the specific embodiments disclosed or shown.

FIG. 1 is a functional representation of a hands-free motion-tracking hair dryer system.

FIG. 2 illustrates an example of some potentially desirable ranges of motion for a hands-fee hair dryer.

FIG. 3A is a functional representation of a remote controller for a hands-free hairdryer system, where the remote control may have the shape and function of a hairbrush, and may include a trackable object 404 and a remote-control interface 304.

FIG. 3B illustrates an example of other hair styling tools that may include a trackable object 404, such as one or more hair rollers 308.

FIGS. 4A-4C illustrates different options for wearing a trackable object.

FIGS. 5A and 5B illustrate two examples for sensing the position of the user of a hands-free hair dryer.

FIGS. 6A and 6B illustrate examples of a flow concentrator.

FIG. 7 is an example of a drone hands-free hair dryer.

FIG. 8A is a front view of another example of hands-free motion-tracking hair dryer system.

FIG. 8B is a side view of FIG. 8A.

FIGS. 9-12 depict the hands-free motion-tracking hair dryer system of FIGS. 8A and 8B, in alternative positions about a user.

FIGS. 13A, 13B and 13C are side, front and top views, respectively, of a sub-assembly of the hands-free motion-tracking hair dryer system of FIGS. 8A and 8B.

FIG. 14 is a perspective view of movement axes of the arm positioning sub-assembly of the hands-free motion-tracking hair dryer system of FIGS. 8A and 8B.

FIG. 15 depicts a hands-free motion-tracking hair dryer system in use, according to another embodiment.

FIG. 16 depicts a hands-free motion-tracking hair dryer system, according to another embodiment.

### DESCRIPTION OF EXEMPLARY EMBODIMENTS

FIG. 1 is a functional representation of a hands-free motion-tracking hair dryer system 100 according to certain embodiments disclosed herein. An example of the system 100 may include a hair dryer 200, a remote controller 300, and a trackable object 400. Several variations and combinations of the dryer 200, remote controller 300, and trackable object 400 are contemplated herein.

In certain embodiments, the dryer 200 can have the standard features of a hair dryer, including a handle 202, an air flow generator (e.g. the fan 204), heating coil 206 and a nozzle 208. In addition, the dryer 200 may include a tracker 210 that can sense the location or motion of the trackable object 400, a wireless communicator 212 that can receive radio frequency transmissions from the remote controller 300, and data storage and/or processor 214. One or more of these components may be coupled to a movable base 216.

The fan 204, heating coil 206 and nozzle 208 may be conventional, as known to those of ordinary skill in the art. The fan 204 preferably generates an air flow, which may be heated by the heating coil 206 and directed out the nozzle 208 towards the user. In various embodiments, the fan 204 and the heating coil 206 may be disposed in differing places within the dryer 200. Certain examples may place both the fan 204 and heating coil 206 in the nozzle 208 section, and other examples may place both the fan 204 and the heating coil 206 in the movable base 216 and “duct” the air flow to the nozzle 208. In a further example, the fan 204 may be disposed in the base 216 and the heating coil 206 may be disposed in the nozzle 208. The tracker 210 may be used to sense the location or movement of the trackable object or the user 10 in different ways, as discussed further herein. The wireless communicator 212 may be used to wirelessly communicate with the remote controller 300 using any known wireless protocols, including WiFi and Bluetooth®.

In certain embodiments, the movable base 216 may move the dryer 200 in a plurality of degrees of freedom (e.g. four to six degrees of freedom). Such degrees of freedom may include, relative to the user, up-down, left-right, forward-away, and rotation about an axis. An approximate initial direction may be manually set by the user 10 prior to use, e.g. set the height of the base 216 relative to the user's hair, and then the base 216 may vary the height in an arc from the top of the user's head to her neck. Controlled positioning of the dryer base 216 may be pivotal, rotational, or linear, and in certain embodiments an initial position and orientation of the dryer base may be manually set by the user 10. The base 216 may be motorized and powered by any typical source, including batteries and domestic AC. The power for the base 216 may be the same as or separate from the power for the dryer 200 itself.

The system 100 optionally includes the remote controller 300. The remote controller 300 may have a communication interface 302 (e.g. a conventional antenna) to wirelessly communicate with the dryer's wireless communicator 212. The remote controller 300 may also have a control interface 304 to control the features of the dryer 200, including on, off, fan speeds (e.g., low, medium, and high) and temperature (e.g., hot, warm, and cold shot). The control interface 304 is preferably intuitively understandable and operated single handedly. In an example, the remote controller 300 may be an application on a wireless device, such as a smartphone.

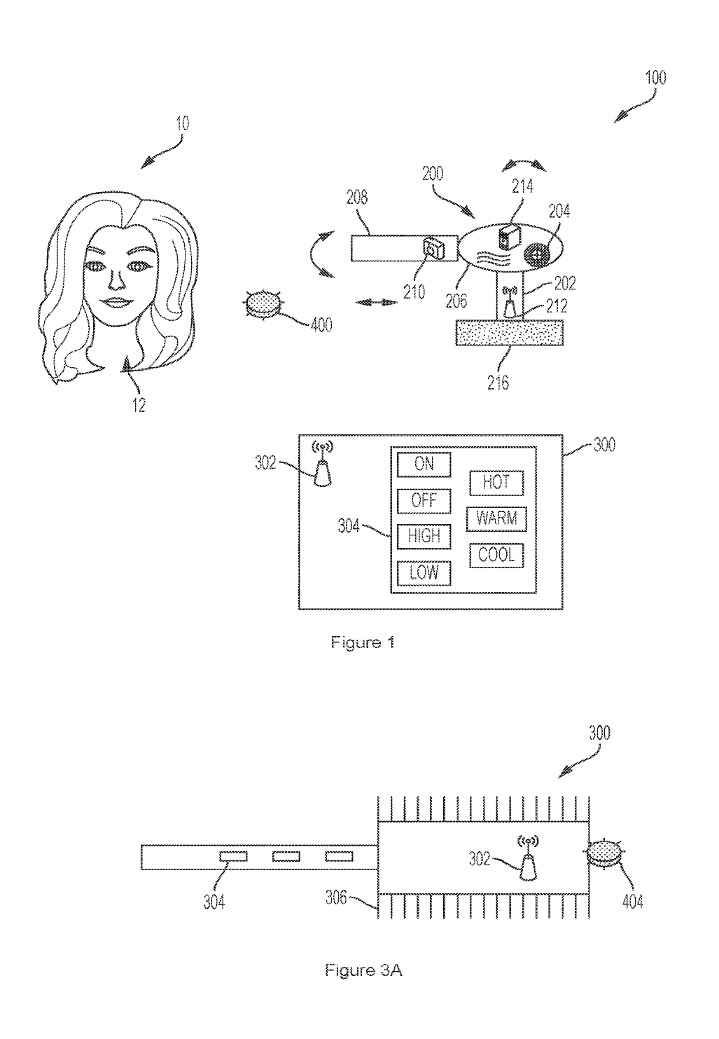

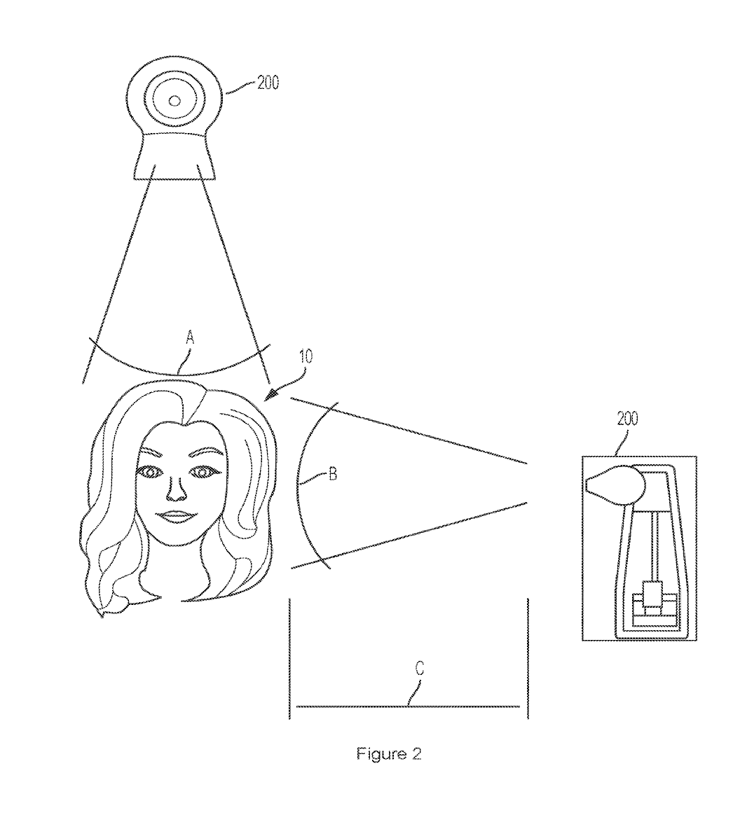

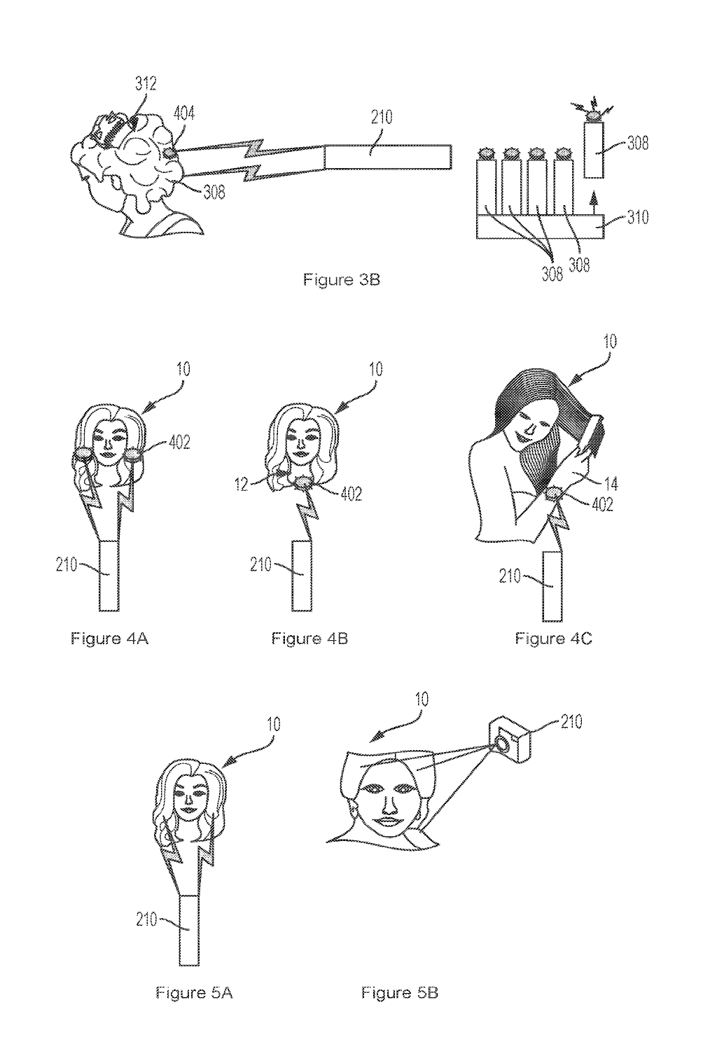

If the system 100 includes the trackable object 400, the tracker 210 may sense the location or movement of the trackable object 400 to provide a control input to the mechanisms that position the dryer base 216. The trackable object 400 is preferably coupled to the user 10, so that the air flow from the dryer 200 may be actively directed to follow the motion of the user 10, particularly her head or hair. The trackable object 400 may take several alternative forms. As shown in the examples of FIGS. 4A-4C, the trackable object 400 may be a wearable trackable object 402. The wearable trackable object 402 may be worn about the user's 10 head or neck region 12. The wearable trackable object 402 may take the form of earrings, bracelets, rings, gloves, or necklaces. Alternatively, the trackable object 400 may be built into and integral with (or removably integral with) the remote controller 300, for example as the trackable object 404 is built in to the controller 300 in FIG. 3A. Referring again to FIG. 1, in an alternative embodiment, the tracker 210 may rely on facial recognition or other conventional technologies that allow tracking of the head, hair, or neck region 12 of the user 10.

In certain embodiments, the system 100 may allow the user 10 to activate the dryer 200 and have the nozzle 208 direct air flow hands-free. The dryer 200 may be activated directly or through the remote controller 300. The tracker 210 may track the location of the trackable object 400 to provide control input to move the base 216 of the dryer 200 to direct the air flow towards the user 10. Such tracking may advantageously allow the user 10 to use both hands to style her hair, as the dryer 200 positions itself.

FIG. 2 illustrates an example of some potentially desirable ranges of motion for the hands-free hair dryer 200 of FIG. 1. For example, the movable base 216 may move the hair dryer 200 left and right within an angular range A and tilt the dryer 200 up and down within an angular range B. Additionally, the tracker 210 may be operable and reliable over a distance C, within which the air flow generated from the conventional fan 204 is preferably effective for drying. In certain embodiments, the angular range A may span as much as 180°, and arc B may span a similar up/down range. In certain embodiments, these ranges may be constrained based on limitations in the hardware or may be set by the user.

FIG. 3A illustrates an example where the remote controller 300 has hair brush bristles 306 to allow the user 10 to control the hair dryer 200 with the same hand that she is styling with. In certain embodiments, the handle of the brush may include the control interface 304 while the body of the brush may house the communication interface 302.

Referring again to FIG. 1, tracking the movements of the user 10 may be accomplished with single component or paired component tracking. The tracker 210 may be configured to track the user, the trackable object 400 (if included), or a hair styling tool. For example, a camera and conventional vision recognition unit in the tracker 210 (e.g. circuit, firmware, or software) may be used to track a user's face, head, or hand, or a hand-held hair styling tool. In the case of paired component tracking, a trackable object 400 that is disposed away from the dryer 200 may be paired with the tracker 210 on the dryer 200, to follow the trackable object's movements. The paired trackable object 400 and tracker 210 may use a conventional tracking or coupling technology that utilizes radio frequency (e.g. RFID), GPS, magnetic sensing, optical vision recognition, color tracking, infrared (IR), capacitive sensing, inertial tracking, inductive sensing, etc. Such paired component tracking requires the trackable object 400 to be placed on or near the user 10 (e.g. wearable by the user 10), with the tracker 210 being designed to follow the trackable object 400. As the trackable object 400 is moved, the tracker 210 communicates a control input, e.g., to move the base 216 or nozzle 208 accordingly.

In certain embodiments, trackable objects may be worn as jewelry or clothing. For example, FIG. 4A illustrates trackable objects 402 that may be worn as earrings, which may frame one boundary (left-right) of the user's face. Trackable objects 402 worn as earrings may also provide location information useful to control vertical displacement (up-down) because a user's ears are typically at a particular height in relation to other features on a user's face, head and neck region 12. The use of two earring trackable objects 402 may also allow for using two tracking points, to enable the tracker 210 to determine the orientation of the user's head based on their relative positions. FIG. 4B depicts a trackable object 402 that is wearable as a necklace in the neck region 12 of the user 10. Other wearable trackable objects 402 that can be used to approximately locate the head and neck 12 of the user 10 may be disposed in headbands, hair ties, barrettes, or hair clips.

FIG. 4C illustrates a trackable object 402 that is wearable as a bracelet. Such a trackable object 402 may enable tracking of the hand 14 of the user—in particular the hand holding the hair brush. In an alternative embodiment, the trackable object 402 may be disposed in a glove. Tracking the user's hands may allow the user 10 to apply hair product and have the dryer 200 still heat the area where the hands 14 are running through the hair.

FIG. 3A is a functional representation of a remote controller 300 for a hands-free hairdryer system, where the remote control may have the shape and function of a hairbrush, and may include a trackable object 404 and a remote-control interface 304. In this embodiment, the tracker 210 tracks the movement of the brush 306 because it is presupposed that air flow should be directed at the brush 306 location. In certain embodiments, the trackable object 404 may be configured to be added to a user's existing conventional brush, so that any brush could be used with the hair dryer 200. Optionally, multiple trackable objects 404 may be used for multiple brushes, so that additional users could share the same hair dryer 200.

FIG. 3B illustrates an example of other hair styling tools that may include a trackable object 404, such as one or more hair rollers 308. In certain embodiments, a plurality of rollers 308 may include trackable objects 404, with each trackable object 404 inactive until the corresponding roller 308 is removed from a heating platform 310. In such embodiments, the tracker 210 tracks only the most recently activated trackable object 404, so that tracking follows each new roller 308 as it is applied. Alternately, the tracker 210 may read multiple trackers 404 in a constellation of hair rollers 308, and track a calculated approximate center 312 of the constellation.

Certain examples of single component tracking are illustrated in FIGS. 5A and 5B. In these examples, the tracker 210 may perform tracking without a tracking object 400. Examples may use optical or audio reflection tracking (e.g., laser or ultrasound) as depicted in FIG. 5A, or camera-based image recognition (e.g., facial recognition) as depicted in FIG. 5B. In such embodiments, the processor 214 may utilize data storage to store users' individual facial profiles and other personalized user settings.

In certain embodiments, both single and paired component tracking may be used to maximize user flexibility. For example, single component tracking may be used for general hands-free drying while the user is performing other tasks. The user can then activate paired component tracking for detailed styling. For example, as the user is trying to straighten or curl her hair, the dryer 200 may be directed at the particular spot where she is brushing. Activating tracking of the trackable object 400 may then allow a greater focus on particular areas of the user's hair.

Optionally, on/off control also may be facilitated using tracking. Once the tracker 210 has recognized either a tracking object 400 or user 10 within a specified range, the dryer may start automatically, and then turn off if the range is exceeded. Proximity tracking may also be used to control a temperature failsafe function. For example, if the tracker 210 determines that the user is too close or remains too long in the hot air flow, the speed or temperature may be lowered, the dryer turned off, or the nozzle 208 moved away from the user.

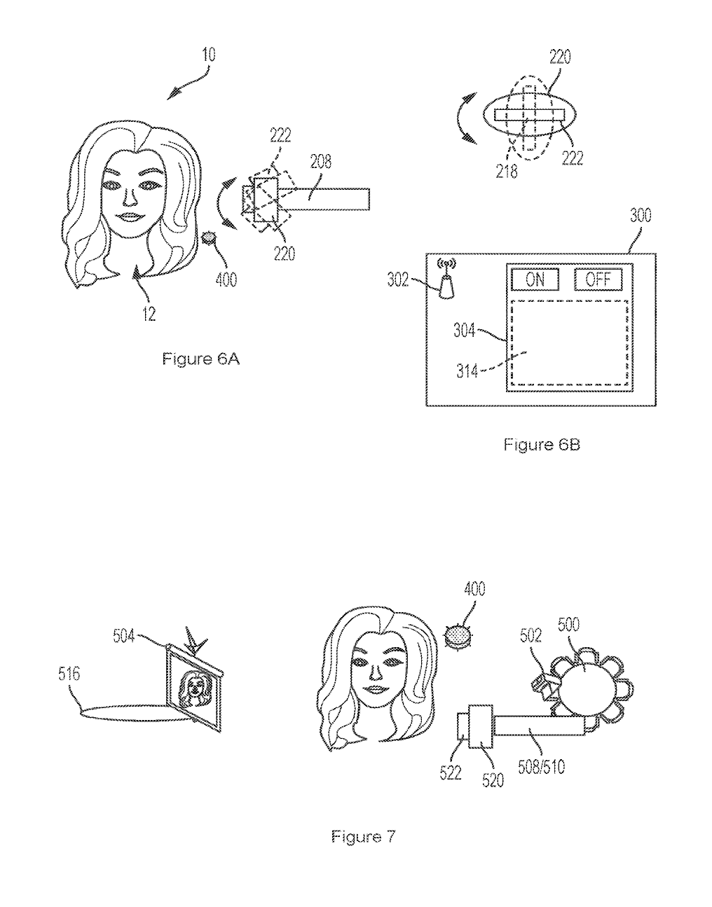

FIGS. 6A and 6B illustrate an example of a flow concentrator 220 attached to the end of the nozzle 208. The flow concentrator 220 may have an elongated opening 222 through which the air flow is restricted and directed. In certain embodiments, the flow concentrator 220 may move in one or more of three directions: up-down, left-right, and rotation about a center axis 218 of the nozzle 208. In certain embodiments, the opening 222 of the flow concentrator 220 can be varied in size to become narrower or wider. For example, the opening 222 may be opened to the size of the nozzle 208 or reduced for minimal flow. In certain embodiments, the flow concentrator 220 may be the only part of the dryer 200 that moves in response to motion tracking.

In another example, the flow concentrator 220 may move in addition to the movement of the dryer 200 and nozzle 208. In that case, the movement of flow concentrator 220 may be “fine tuning” of the coarser movements of the dryer 200 on the base 216. In this example, the base 216 may move the nozzle 208 within proximity of the user 10 and then the flow concentrator 220 may move to more finely track movements by the user 10. For example, when the user 10 is styling long hair, she may separate the hair and style small sections at a time. The nozzle 208 may remain generally still as the flow concentrator 220 moves up and down following a tracking object 400 or the brush 306. Furthermore, the remote controller 300 may have a control interface 304 (e.g. a touch pad 314) for adjusting or positioning the flow concentrator 200.

FIG. 7 illustrates an example of hands-free hair drying in which a small drone 500 hovers in flight around the user 10. Typical elements of a drone are known to those of ordinary skill in the drone arts and can include a power supply, motor, rotary engine, rotating blades, gyroscopic elements, and/or wireless communications. The drone 500 may include an air flow nozzle 508 along with a concentrator 520/522, and a tracker 510, similar to the hands-free hair dryer embodiments described above. This example gives the user extra mobility, as she can travel outside of a small prescribed range usually associated with typical hair dryers based on the length of the power cord. For example, a user might travel from room to room while still drying her hair. The drone 500 can be programmed to maintain a certain distance from a tracking object 400 or the user 10 under all or certain circumstances. The drone 500 may have a drone base 516 that allows the drone 500 to dock and charge between uses.

In an alternative embodiment, the drone 500 may be equipped to perform a “fly-by” or “back image” function. For example, the drone 500, in addition to having hair drying capabilities, may also have an imaging unit 502, e.g. a still or motion camera. The imaging unit 502 may be a part of the tracker 510 or separate therefrom. The user 10 may request that the drone 500 image all or a section of the user's hair so the user 10 can see parts of her hair that are difficult to see or get the overall look of her style. In such embodiments, the drone base 516 may include a monitor 504 that receives the image information (e.g. real time video or snapshots) from the imaging unit 502. Such drone features may reduce the need for the user to style her hair before a mirror, giving her even more freedom to choose where she styles her hair. Alternatively, the monitor 504 may be disposed separate from the base 516, for example the monitor 504 may be mounted to the drone 500 itself, or the images transmitted to the user's smartphone. Alternately, the drone 500 may have a projector to project the image onto any surface.

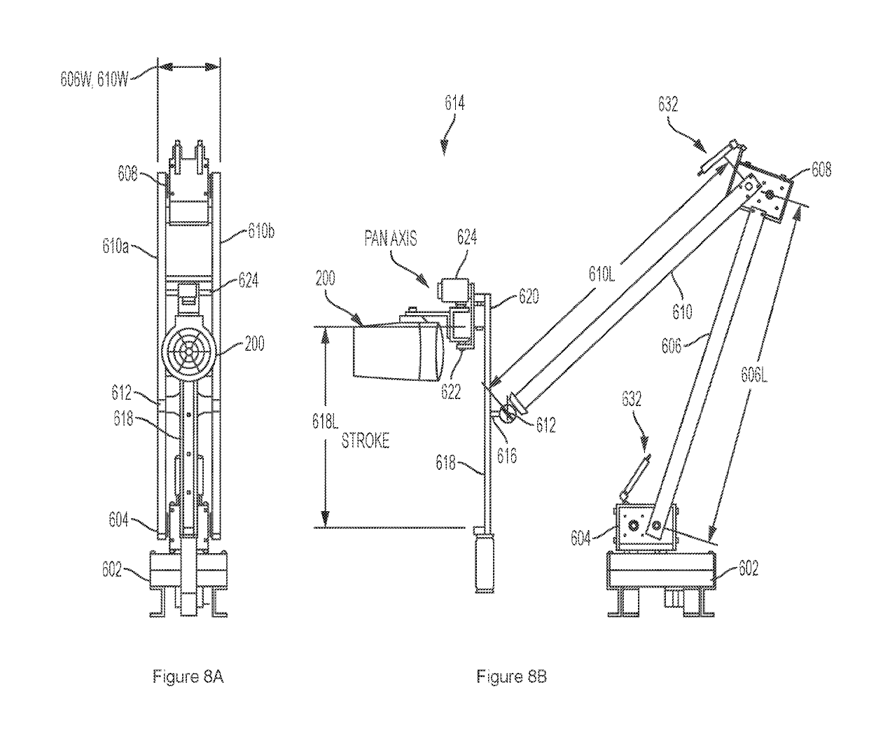

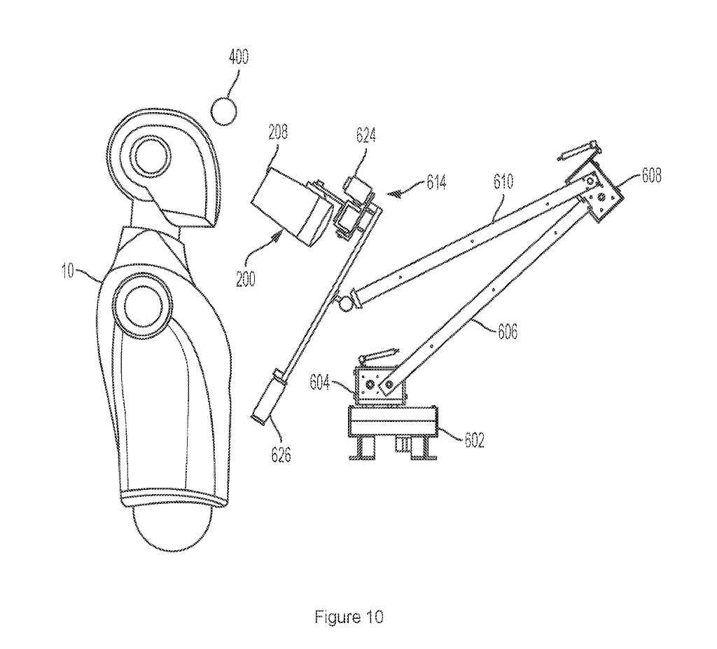

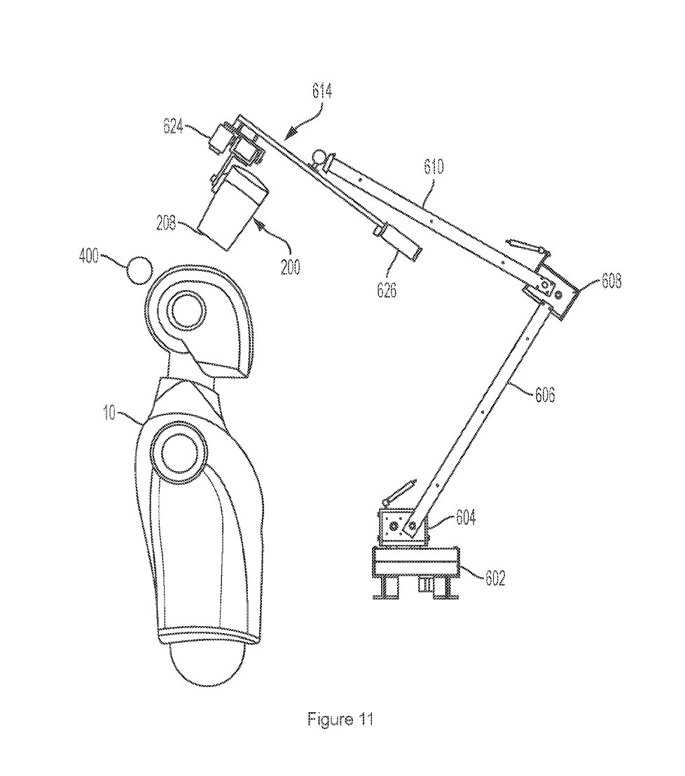

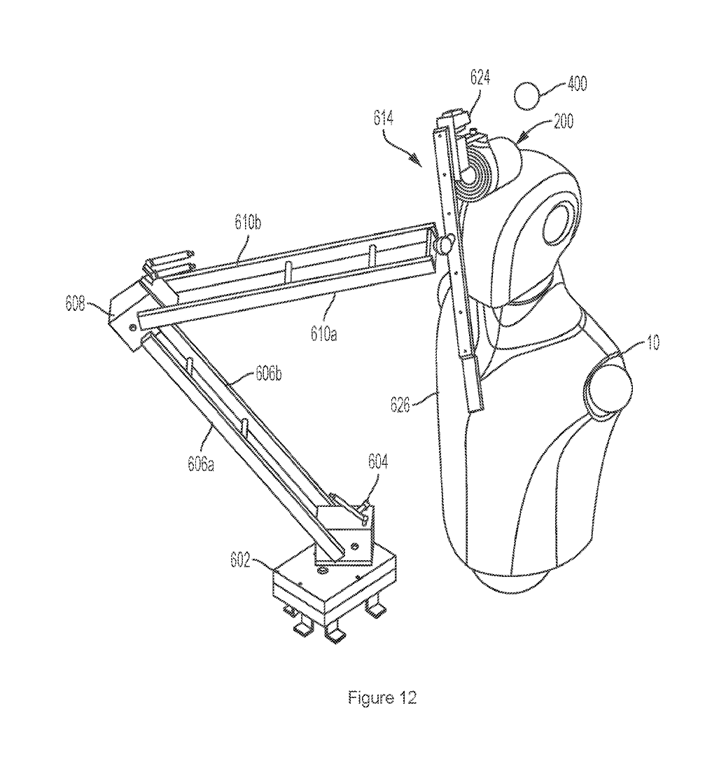

FIGS. 8-14 illustrate another example embodiment of a hand-free motion tracking hair dryer system, which may include a hair dryer 200, a trackable object 400, and a base 602 which can be placed on or mounted to any generally flat surface (e.g. countertop, ceiling, or wall). FIGS. 8A and 8B illustrate a front and side view of the hair dryer system. In a preferred embodiment, a first motor 604 may be attached to the base 602 to rotate a lower arm 606. In one example, there can be more than one lower arm, 606a, 606b. A second motor 608 may be disposed at the distal end of the lower arm 606, so as to rotate an upper arm 610 relative to the lower arm 606. The lower and upper arms 606, 610 may have lengths 606L, 610L, respectively, and such lengths need not be equal.

As with the lower arm 606 in the embodiment of FIGS. 8-14, there may be multiple upper arms 610a, 610b, and the number of lower and upper arms 606, 610 need not be equal. If there are multiple arms 606, 610 there may be a distance between them 606W, 610W, which need not be equal. The gap between the arms (if any) may have cross-bar stabilizers to allow the arms 606a, 606b, 610a, 610b to act as a stable pair.

In certain embodiments, a joint 612 (e.g. a ball joint) may be disposed at a distal end of the upper arm 610—i.e. at the end opposite from the second motor 608—to pivotably attach a dryer movement system 614 to the upper arm 610 at a joint interface 616. The dryer movement system 614 may include a dryer slide 618 that may translate the hair dryer 200 along the axis of the dryer slide 618. For example, a dryer carriage 620 may slide back and forth along the dryer slide 618, to span a stroke distance 618L. The dryer carriage 620 may have a dryer panning pivot 622 that allows the dryer 200 to be pivoted about a pan axis that is approximately parallel to the dryer slide 618, to adjust the orientation of the dryer air flow transverse to the movement of the carriage 620 on the slide 618. The dryer movement system 614 may respond to control inputs from a tracker 624 to track movements of the user 10, as described previously herein.

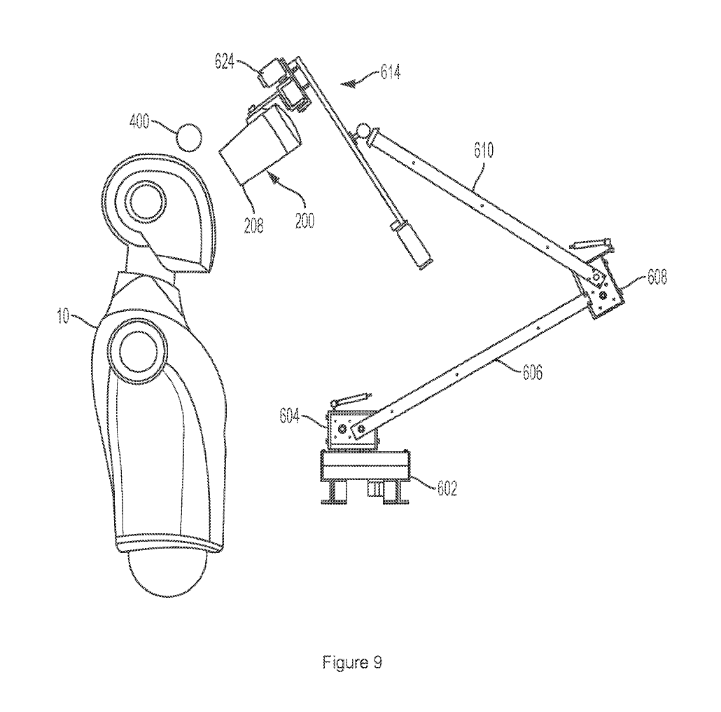

FIGS. 9-12 illustrate an example hair dryer system drying the hair of a user 10, while the system's tracker 624 tracks the movement of a trackable object 400 to provide control inputs to drive the first and second motor units 604, 608. The motors 604, 608 may be powered by any typical source, including batteries or a domestic AC power outlet. The motor units may move the arms 606, 610 and the dryer 200 on the dryer movement system 614, to position the dryer nozzle 208 to follow the movements of the user 10. In one example, the first motor 604 may have up to 360° of rotational freedom with respect to the base 602. The arms 606, 610 may each have about 160° range of angular motion with respect to the motors 604, 608. In certain embodiments, the dryer 200 may translate along the entire stroke distance 618L and pivot up to about 100° each way with respect to the pan axis. The angular and translational ranges may be different according to alternative embodiments.

In certain embodiments, a control interface may be built into the base 602 to enable the user to select various desired settings for the hair dryer system. Alternately, any of the remote controllers 300 discussed above may be used for that purpose, including a smartphone interface. The control interface or remote controller 300 may optionally be capable of powering the system on and off, and setting the temperature and the force of the air from the dryer 200.

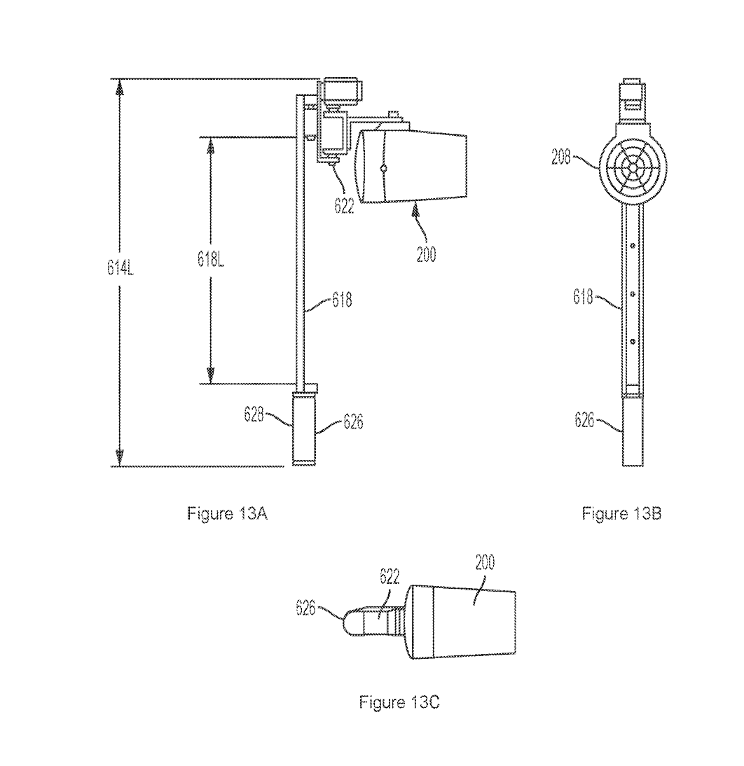

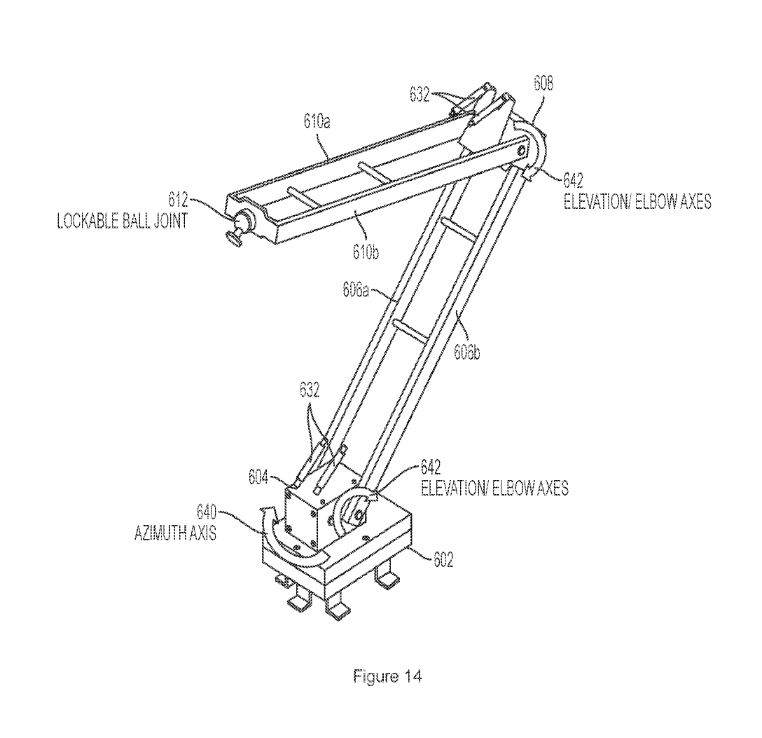

FIGS. 13A-13C further illustrates the dryer movement system 614 of FIGS. 9-12. Now referring additionally to FIGS. 13A-13C, the dryer movement system 614 may include a manual handle 626. In this embodiment, the handle 626 may have one or more buttons 628 to allow for manually disengaging or reengaging optional locks at the joints between the base 602, motors 604, 608, arms 606, 610, and the dryer movement system 614. This may allow the user 10 to manually position the dryer nozzle 208 instead of, or in addition to, automatic tracking. The dryer movement system 614 may have a length 614L from the tracker 624 to the handle 626. To assist with both motorized and manual movement, the arms may optionally include weight assist springs 632 (as shown in FIGS. 8B and 14) to stabilize the arms by balancing the weight of the arms 606, 610 and the second motor 208.

FIG. 14 illustrates an example of the movement axes of the motors 604, 608 and the arms 606, 610. In certain embodiments, the azimuth axis 640 may allow up to 360° of rotational freedom in either direction, and the first motor 604 may be locked at any angular position about the axis 640. In certain embodiments, both motors 604, 608 may have elevation/elbow axes 642. The elevation/elbow axes 642 may have approximately 160° range of motion and may be lockable in angular position. In certain embodiments, the joint 612 may provide approximately 100° of freedom and be lockable in place. In this way, the arms 606, 610 may provide a plurality of degrees of freedom (e.g. three degrees of freedom).

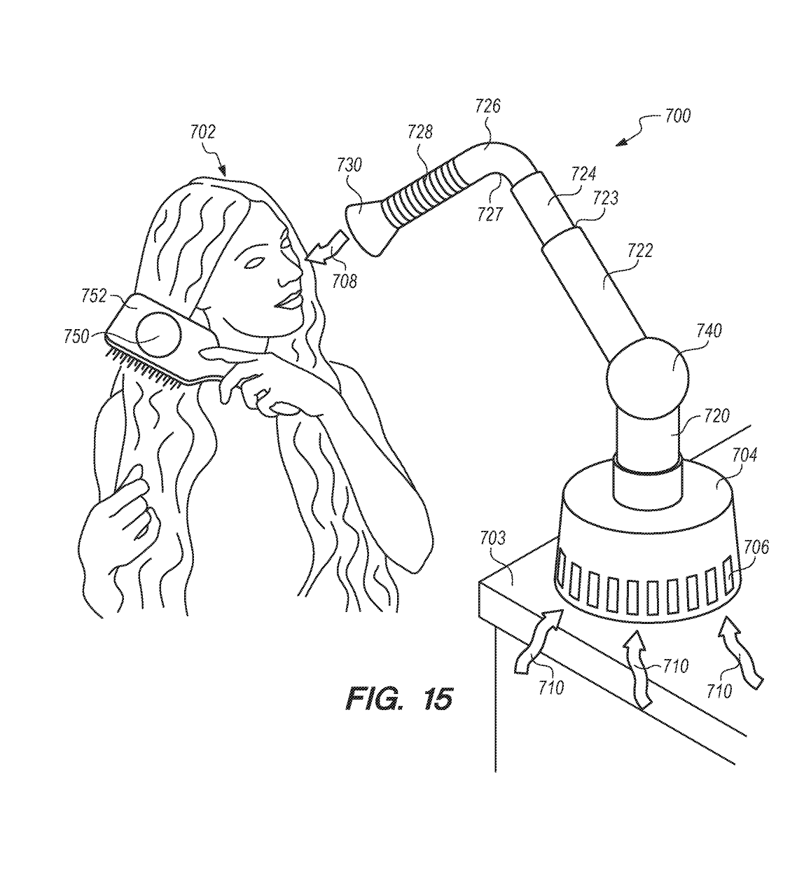

FIG. 15 depicts a hands-free motion-tracking hair dryer system 700 in use by a moving user 702, according to another embodiment. The user 702 is considered herein to be a moving user even if only a part of the user 702 (e.g. her head or hand) is moving. The system 700 includes a stationary base 704 that houses an air flow generator 706 to generate an inlet airflow 710 and an outlet airflow 708. For example, the air flow generator may be a conventional motorized fan 706 (e.g. an axial or centrifugal fan or blower), or another conventional means to generate air flow (e.g. an electrostatic fluid flow generator), which produces an outlet airflow having a velocity in the range 8 m/s to 16 m/s. The stationary base 704 optionally may be supported by a household surface 703, for example by being weighted and resting on the surface 703 or being attached to a similar horizontal or vertical surface, and does not need to be held by the hands of the user 702.

In the embodiment of FIG. 15, the system 700 includes a conduit 720, 722, 724, 726 through which the air flow 708, 710 passes and that channels the air flow 708, 710 to an outlet nozzle 730. In the embodiment of FIG. 15, the conduit includes an inlet portion 720 that is coupled to the air flow generator 706, telescoping portions 722 and 724, and an outlet portion 726 that is coupled to the nozzle 730. The outlet portion 726 optionally includes a flexible portion 728 that can be easily set in a desired bent shape by the user 702.

In the embodiment of FIG. 15, the conduit includes a telescoping joint 723 that permits longitudinal translation (e.g. driven by a motorized, pneumatic, or hydraulic actuator) between telescoping portions 722 and 724 to permit changes in the length of the conduit between the air flow generator 706 and the outlet nozzle 730, while the air flow 708, 710 is passing therethrough. Preferably, the system 700 includes an actuator control circuit that drives the longitudinal translation of the telescoping portion 724 in response to the motion of the user 702 (as sensed by a motion tracker). For example, the longitudinal translation may be driven at a rate of 150 mm/sec to 275 mm/sec to change the conduit length by a maximum change in the range of 100 mm to 400 mm. In certain preferred embodiments, the system 700 further includes a trackable object 750 which may be wearable by the user 702 or attached to a hair styling tool (e.g. the hairbrush 752 shown in FIG. 15).

In the embodiment of FIG. 15, the conduit further comprises an angular deflection joint 740 (e.g. a hollow ball joint having three angular degrees of freedom, or a hollow hinge joint having one or two angular degrees of freedom, etc.) that allows the user to manually orient the conduit portions 722, 724, and 726 in a desired angular direction. The angular deflection joint 740 optionally may be disposed between the air flow generator 706 and the telescoping joint 723, as shown in FIG. 15. Alternatively, the angular deflection joint 740 may be disposed between the telescoping joint 723 and the outlet nozzle 730, although that is less preferred because it would increase the moving mass of the actuated distal portions 724, 726 of the conduit.

The outlet portion 726 of the conduit optionally includes a bend 727 to direct the outlet air flow 708 in a direction that is transverse to a longitudinal axis of the telescoping portions 722, 724. Such transverse orientation of the nozzle 730 may be desirable so that longitudinal actuation of the telescoping portion 724 to change the length of the conduit will move the outlet air flow 708 in a transverse direction, and thereby change the location of its impingement on the user 702. Otherwise, if the outlet air flow 708 were parallel with the longitudinal axis of the telescoping portions 722, 724, then the location of air flow impingement on the user 702 would not move, but rather merely become more concentrated (nozzle 730 closer to the user 702) or more diffuse (nozzle 730 further away from the user 702).

The system 700 may include a conventional heating element to selectively heat the air flow 708, which may be disposed in the outlet nozzle 730 or adjoining conduit in certain embodiments. In such embodiments, most of the length of the conduit is advantageously not incidentally heated by the air flow 708. Alternatively, the conventional heating element may be disposed in or adjacent the stationary base 704 or the air flow generator 706 (e.g. in conduit portion 720). In such embodiments, the conventional heating element advantageously does not add moving mass to the actuated conduit portions 724, 726. In certain embodiments, the conventional heating element may be selectively powered to result in an air flow temperature in the range of room temperature to 90° C.

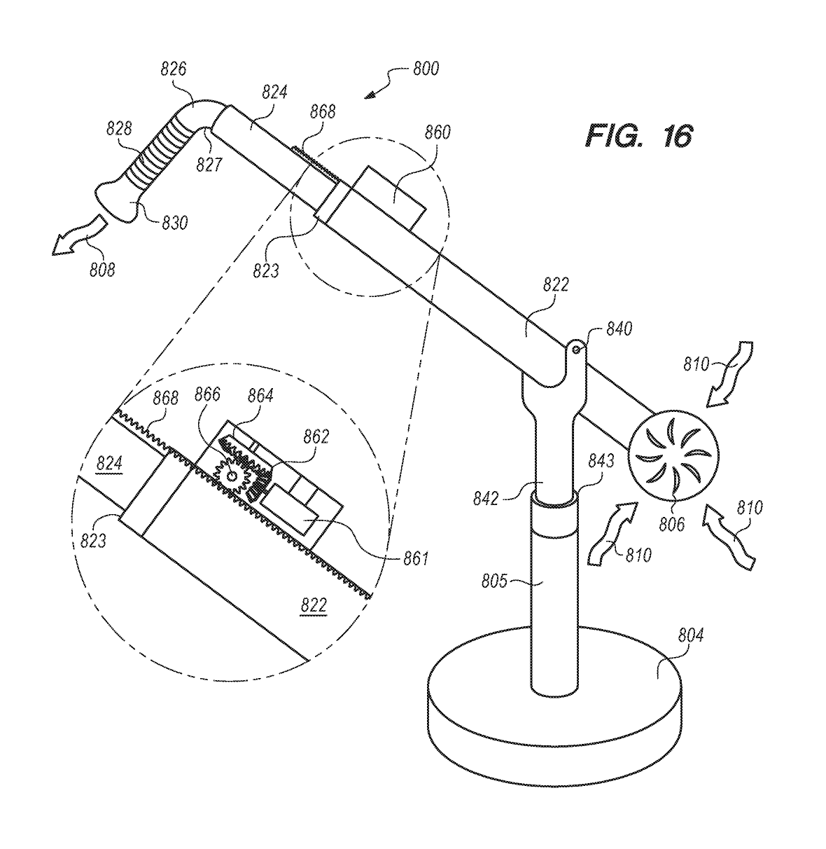

FIG. 16 depicts a hands-free motion-tracking hair dryer system 800, according to another embodiment. The system 800 includes a stationary base 804 that optionally may be supported by a household surface, and does not need to be held by the hands of the user. The system 800 further includes a conventional air flow generator 806 to generate an inlet airflow 810 and an outlet airflow 808. For example, the conventional air flow generator 806 may be an axial or centrifugal fan, blower, or electrostatic flow generator.

In the embodiment of FIG. 16, the system 800 includes a conduit 822, 824, 826 through which the air flow 808, 810 passes and that channels the air flow 808, 810 to an outlet nozzle 830. In the embodiment of FIG. 16, the conduit includes a non-actuated telescoping portion 822 that is coupled to the air flow generator 806, an actuated telescoping portion 824, and an outlet portion 826 that is coupled to the nozzle 830. The outlet portion 826 optionally includes a flexible portion 828 that can be easily set in a desired bent shape by the user.

In the embodiment of FIG. 16, the stationary base 804 supports the non-actuated telescoping portion 822 of the conduit at a pivotal joint 840 that connects a vertical extension 805, 842 of the base 804 to the conduit. In certain embodiments the pivotal joint 840 may have sufficient degrees of freedom (e.g. swivel and tilt) to allow the user to manually orient the non-actuated telescoping portion 822 in a desired angular direction for hair styling. The vertical extension 805, 842 can optionally be a single component or alternatively two telescoping components having a length that can be adjusted manually at base telescoping joint 843 to provide an additional degree of freedom of manual adjustment (i.e. adjustment of the height of the non-actuated telescoping portion 822).

In the embodiment of FIG. 16, the conduit includes a conduit telescoping joint 823 that permits longitudinal translation (e.g. driven by a motorized, pneumatic, or hydraulic actuator 860) between telescoping portions 822 and 824 to permit changes in the length of the conduit between the air flow generator 806 and the outlet nozzle 830, while the air flow 808, 810 is passing therethrough. Preferably, the system 800 includes an actuator control circuit that drives the actuator 860 to cause longitudinal translation of the telescoping portion 824 in response to the motion of the user (as sensed by a motion tracker).

In the embodiment of FIG. 16, the actuator 860 may include an electrically-driven stepper motor 861 that drives a pinion gear 866 (e.g. via transfer gears 862 and 864), and that is attached to the non-actuated telescoping portion 822 of the conduit. The actuated telescoping portion 824 may include an attached linear rack gear 868 that is engaged with the pinon gear 866, so that it can be automatically telescopically actuated relative to the non-actuated telescoping portion 822 of the conduit in a closed-loop manner to follow motions of the user.

The outlet portion 826 of the conduit optionally includes a bend 827 to direct the outlet air flow 808 in a direction that is transverse to a longitudinal axis of the telescoping portions 822, 824. Such transverse orientation of the nozzle 830 may be desirable so that longitudinal actuation of the telescoping portion 824 to change the length of the conduit will move the outlet air flow 808 in a transverse direction, and thereby change the location of its impingement on the user. Otherwise, if the outlet air flow 808 were parallel with the longitudinal axis of the telescoping portions 822, 824, then the location of air flow impingement on the user would not move, but rather merely become more concentrated (nozzle 830 closer to the user) or more diffuse (nozzle 830 further away from the user). In certain embodiments the bend 827 may be flexible.

The system 800 may include a conventional heating element to selectively heat the air flow 808, which may be disposed in the outlet nozzle 830 or adjoining conduit in certain embodiments. In such embodiments, most of the length of the conduit is advantageously not incidentally heated by the air flow 808. Alternatively, the conventional heating element may be disposed in or adjacent the air flow generator 806 (e.g. in conduit portion 822). In such embodiments, the conventional heating element advantageously does not add moving mass to the actuated conduit portions 824, 826.

In the foregoing specification, the invention is described with reference to specific exemplary embodiments, but those skilled in the art will recognize that the invention is not limited to those. It is contemplated that various features and aspects of the invention may be used individually or jointly and possibly in a different environment or application. The specification and drawings are, accordingly, to be regarded as illustrative and exemplary rather than restrictive. For example, the word “preferably” is used herein to consistently include the meaning of “not necessarily” or optionally. “Comprising,” “including,” and “having,” are intended to be open-ended terms.

We claim:

1. A motion-tracking hair dryer system for use by a moving user, the system comprising:
a base,
an air flow generator;
a conduit through which the air flow passes, the conduit being coupled to the air flow generator and channeling the air flow to an outlet nozzle;
a heating element to selectively heat the air flow;
the conduit including a telescoping joint that is disposed between the air flow generator and the outlet nozzle, the telescoping joint permitting the conduit to change its length while the air flow is passing therethrough;
an actuator that changes the length of the conduit at the telescoping joint;
a motion tracker that can sense a motion of the user;
an actuator control circuit that drives the actuator based on the motion sensed by the motion tracker, to adjust the conduit length in response to the motion of the user.

2. The motion-tracking hair dryer system of claim 1, wherein the air flow generator is disposed in the base.

3. The motion-tracking hair dryer system of claim 2, wherein the base is a stationary base that supports the air flow generator and the conduit without being held by the user.

4. The motion-tracking hair dryer system of claim 1, wherein the conduit further comprises an angular deflection joint that allows the user to manually orient the conduit in a desired angular direction.

5. The motion tracking hair dryer system of claim 4, wherein the angular deflection joint is disposed between the air flow generator and the telescoping joint.

6. The motion tracking hair dryer system of claim 4, wherein the angular deflection joint is a hollow ball joint having three angular degrees of freedom.

7. The motion tracking hair dryer system of claim 1, further comprising a trackable object, the motion tracker sensing the location of the trackable object, and thereby tracking the motion of the user.

8. The motion tracking hair dryer system of claim 7, wherein the trackable object is wearable on the user.

9. The motion tracking hair dryer system of claim 8, wherein the trackable object is comprised by one of the group consisting of an earring, a necklace, a ring, a barrette, and a bracelet.

10. The motion tracking hair dryer system of claim 7, wherein the trackable object is incorporated into a hair styling tool.

11. The motion tracking hair dryer system of claim 10 wherein the hair styling tool is one of a hair brush, a comb, and a hair roller.

12. The motion tracking hair dryer system of claim 11 wherein the hair styling tool includes a remote controller that can communicate user adjustments to at least one of a rate and temperature of the air flow.

13. The motion tracking hair dryer system of claim 11 wherein the trackable object is inactive until the hair roller is removed from a heating platform.

14. The motion tracking hair dryer system of claim 7, wherein the motion tracker senses the location of the trackable object by use of at least one of RFID, GPS, magnets, color tracking, infrared (IR), visual recognition and radio frequency.

15. The motion-tracking hair dryer system of claim 1, wherein the air flow generator is disposed at an inlet end of the conduit, and the base supports the conduit at a supporting joint that connects the base and the conduit.

16. The motion-tracking hair dryer system of claim 1, wherein the heating element is disposed in the outlet nozzle.

17. The motion-tracking hair dryer system of claim 1, wherein the outlet nozzle further includes a flow concentrator.

18. The motion tracking hair dryer system of claim 1, wherein the motion tracker includes a camera and a vision recognition unit to track the motion of the user, the motion of the user being a motion of at least one of the user's head, face, and hand.

19. The motion tracking hair dryer system of claim 1, wherein the actuator comprises a stepper motor that drives a pinion gear and that is attached to a first portion of the conduit, and a rack gear that is attached to a second portion of the conduit and that is engaged with the pinon gear, the second portion of the conduit being telescopically moveable relative to the first portion of the conduit.

20. The motion tracking hair dryer system of claim 1, wherein the conduit further comprises a bend to orient the outlet nozzle towards a direction that is transverse to a longitudinal axis of the telescoping joint.

21. The motion tracking hair dryer system of claim 1, wherein the air flow generator is a fan.

22. The motion-tracking hair dryer system of claim 15, wherein the supporting joint is a pivotal joint.
